(19) United States
(12) Patent Application Publication
(10) Pub. No.: US 2021/0167563 A1
(43) Pub. Date: Jun. 3, 2021

(54) COAXIAL CABLE ASSEMBLIES HAVING PINCHING AND GRIPPING ELEMENTS

(71) Applicant: CORNING OPTICAL COMMUNICATIONS RF LLC, Glendale, AZ (US)

(72) Inventors: Jan Michael Clausen, Vordingborg (DK); Michael Ole Matzen, Vordingborg (DK)

(21) Appl. No.: 17/109,216

(22) Filed: Dec. 2, 2020

Related U.S. Application Data
(60) Provisional application No. 63/059,701, filed on Jul. 31, 2020.
(60) Provisional application No. 62/942,742, filed on Dec. 2, 2019.

(51) Int. Cl. H01R 24/56; H01R 4/18; H01R 43/048

(52) U.S. Cl. CPC H01R 24/564; H01R 2103/00; H01R 43/048; H01R 4/183

(57) ABSTRACT

A coaxial connector assembly for attachment to a corrugated coaxial cable, includes a rear outer body, having an engagement element to be received over a portion of the corrugated coaxial cable and a front subassembly. The front subassembly is configured for partial insertion into the rear outer body and includes a front body shell, having a deformable end portion and a rearward annular extension spaced apart from the deformable end portion such that a pinching space is formed between the deformable end portion and the rearward annular extension. Upon coupling of the rear outer body with the front body shell, a portion of the corrugated outer conductor is configured for positioning within the pinching space.

### CROSS-REFERENCE TO RELATED APPLICATIONS

This application claims priority to U.S. Application Ser. No. 62/942,742, filed Dec. 2, 2019, and U.S. Application Ser. No. 63/059,701, filed Jul. 31, 2020. The content of each priority application is incorporated herein by reference in its entirety.

### BACKGROUND

The present disclosure generally relates to coaxial cable assemblies, and particularly connector assemblies, having pinching and gripping elements, that connect with coaxial cables, having corrugated outer conductors.

A coaxial cable is characterized by having an inner electrical conductor, an outer electrical conductor, and a dielectric between the inner and outer electrical conductors. The inner electrical conductor may be hollow or solid. At the end of coaxial cable, a connector or connector assembly is attached to allow for mechanical and electrical coupling of the coaxial cable.

Connectors and connector assemblies for attachment to coaxial cables have been used throughout the coaxial cable industry for a number of years. One type of coaxial cable has an annularly corrugated outer conductor and a plain cylindrical inner conductor. Generally, connectors and connector assemblies that attached to these types of coaxial cables are different from those where the outer electrical conductors are smooth or uncorrugated.

For example, one connector assembly type includes a single annular clamping portion that meshes with the last valley or outermost valley of the corrugated outer conductor, providing a single circumferential point of contact. Without additional axial reinforcement from the coaxial cable connector, physical gyrations of the cable found in field applications due to weather and vibration can cause undue stress and, ultimately, material fatigue of the corrugated cable outer conductor.

The aforementioned example clearly shows there is a continuing need for improved high performance coaxial cable connectors and connector assemblies. There is a particular need for connectors and connector assemblies that can be installed and uninstalled easily and quickly, particularly under field conditions. Also, since these connectors and connector assemblies are generally installed in the field, they should be configured for pre-assembly, so that the possibility of dropping and losing small parts, misplacing o-rings, damaging or improperly lubricating o-ring, or other assembly errors in the field are minimized. Additionally, it should be possible for the coaxial cable connector to be installed and removed without the use of any special tools.

In view of the aforementioned needs, as well as other issues with prior connector and connector assembly designs, alternatives are desired.

### SUMMARY

Disclosed herein are various embodiments of coaxial cable connector assemblies for attachment to a corrugated coaxial cable, having a center conductor, a dielectric surrounding the center conductor, and a corrugated outer conductor surrounding the dielectric. Related methods are also disclosed herein.

According to a first aspect, a coaxial connector assembly, for attachment to a corrugated coaxial cable, includes a rear outer body, having an engagement element, to be received over a portion of the corrugated coaxial cable and a front subassembly. The front subassembly is configured for partial insertion into the rear outer body. The front subassembly includes, among other things, a front body shell, having a deformable end portion and a rearward annular extension spaced apart from the deformable end portion such that a pinching space is formed between the deformable end portion and the rearward annular extension. Upon coupling of the rear outer body with the front body shell, a portion of the corrugated outer conductor is configured for positioning within the pinching space. In addition, during the coupling, the deformable end portion is inwardly urged toward the rearward annular extension by the engagement element such that the portion of the corrugated outer conductor is pinched while positioned within the pinching space.

According to a second aspect, a coaxial connector assembly includes a front subassembly and an alternative version of a rear outer body to be received over a portion of the corrugated coaxial cable. The rear outer body includes an engagement element that slidingly engages with the corrugated outer conductor upon coupling. The front subassembly is configured for partial insertion into the rear outer body. The front subassembly includes a front body shell, having an end portion and a ferrule spaced apart from the end portion such that a gripping space is formed between the end portion and the ferrule. Upon coupling of the rear outer body (402) with the front body shell, a portion of the corrugated outer conductor is positioned within the gripping space and the ferrule is inwardly urged toward the end portion by the engagement element such that the portion of the corrugated outer conductor is gripped while positioned within the gripping space.

According to a third aspect, a method of making a connector assembly to be attached to a corrugated coaxial cable includes the steps of: forming a rear outer body to be received over a prepared end of the corrugated coaxial cable, with the rear outer body including an engagement element defined therein; forming a front subassembly to engage the rear outer body, with the front subassembly including a front body shell having a deformable end portion and a rearward annular extension spaced apart from the deformable end portion such that a pinching space is formed between the deformable end portion and the rearward annular extension, coupling the rear outer body with the front body shell, and positioning a portion of the corrugated outer conductor within the pinching space.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1A is an exploded cross-sectional view of a seal-cable assembly;

FIG. 1B is an assembled cross-sectional view of the seal-cable assembly shown in FIG. 1A;

FIG. 2A is a cross-sectional view of the seal-cable assembly shown in FIG. 1A before assembly with a first rear outer body embodiment;

FIG. 2B is a cross-sectional view of the seal-cable assembly shown in FIG. 1A after assembly with the rear outer body shown in FIG. 2A;

FIG. 3 is a cross-sectional view of a first connector subassembly in accordance with embodiments disclosed herein;

FIG. 4 is a cross-sectional view of the first connector subassembly shown in FIG. 3 assembled with the rear outer body and the seal-cable assembly shown in FIG. 2B;

FIG. 5 is a cross-sectional view of the seal-cable assembly shown in FIG. 1A after assembly with a second rear outer body embodiment;

FIG. 6 is a cross-sectional view of a second connector subassembly in accordance with embodiments disclosed herein;

FIG. 7 is a cross-sectional view of the second connector subassembly shown in FIG. 6 assembled with the rear outer body shown and the seal-cable assembly shown in FIG. 5;

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the features and limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates are used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

Disclosed herein are embodiments of connector assemblies 200, 400 configured for positioning onto a prepared cable-seal assembly.

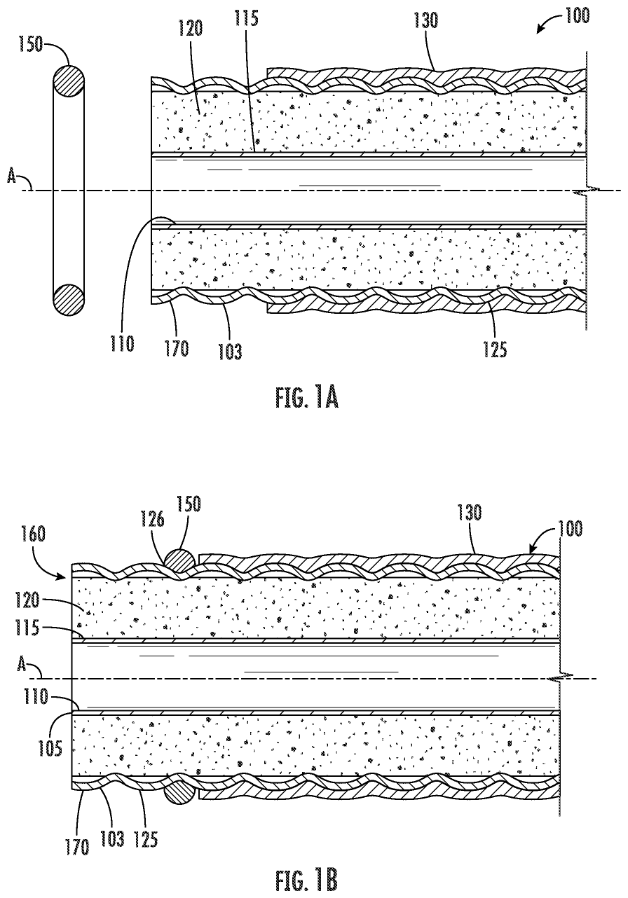

FIGS. 1A and 1B show cross sectional views of a portion of a corrugated coaxial cable 100 and a seal 150, configured as an o-ring. Specifically, FIG. 1A shows an exploded view of the corrugated coaxial cable 100 and the seal 150 and FIG. 1B shows the corrugated coaxial cable 100 and the seal 150 assembled to form a cable-seal assembly 160. The cable-seal assembly 160 can be assembled with the connector subassemblies disclosed herein, as will be further described.

The corrugated coaxial cable 100 includes a center conductor 105, a dielectric 120, a corrugated outer conductor 125, and a jacket 130. The center conductor 105 is annular and thus includes an inside diameter 110 and an outside diameter 115. The dielectric 120 surrounds the outside diameter 115 of the center conductor 105, the corrugated outer conductor 125 surrounds the dielectric 120, and the jacket 130 surrounds the corrugated outer conductor 125. In both FIGS. 1A and 1B, a forward end 103 of the corrugated coaxial cable 100 is shown in a “prepared state,” meaning that an end of the corrugated coaxial cable 100 a portion of the jacket 130 has been removed such that the corrugated outer conductor 125 is fully exposed and ready for positioning in a connector assembly.

As shown particularly in FIG. 1B, the seal 150 is configured for positioning adjacent to or within an outermost valley 126 of the corrugated outer conductor 125. In this embodiment, the seal 150 is configured as an o-ring, having a circular cross-section. Other seal configurations, with different cross-sectional shapes, however, may be used.

Each embodiment of the connector assemblies disclosed herein is preferably preassembled before shipment and includes a rear outer body and a front subassembly. Each rear outer body and front subassembly are thus attached to one another so that they can be shipped from the factory to the field and then installed onto a prepared end of a corrugated coaxial cable.

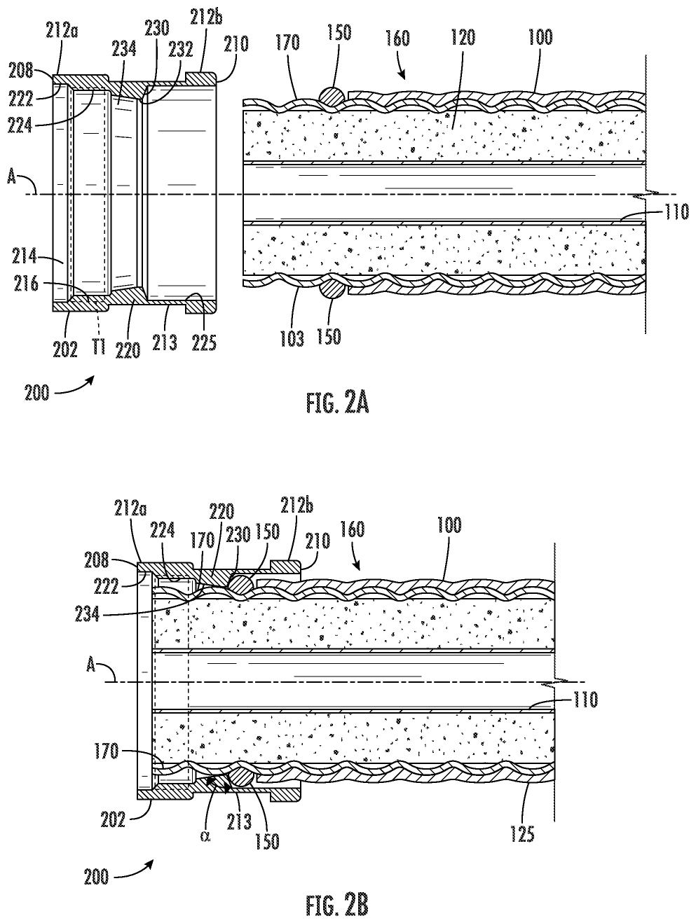

FIG. 2A shows an exploded view of a rear outer body 202 and a cable-seal assembly 160 with the cable being in a prepared state having a prepared end 170, while FIG. 2B shows the rear outer body 202 positioned onto the prepared end 170, forming a partially assembled connector assembly 200. The rear outer body 202 is preferably manufactured from at least one metallic material such as brass and plated with a conductive, corrosion resistant material such as a nickel-tin alloy.

Referring to FIGS. 2A and 2B, the rear outer body 202 includes a front end 208, a back end 210, external gripping portions 212a, 212b, a recess 213 positioned between the external gripping portions 212a, 212b, and an outer body opening 214 extending between the front end 208 and the back end 210 with respect to a longitudinal axis A. The rear outer body 202 further includes a threaded portion 216 adjacent the front end 208 for engagement with a front subassembly 204, which will be further described. The threaded portion 216 is represented schematically by dashed line T1.

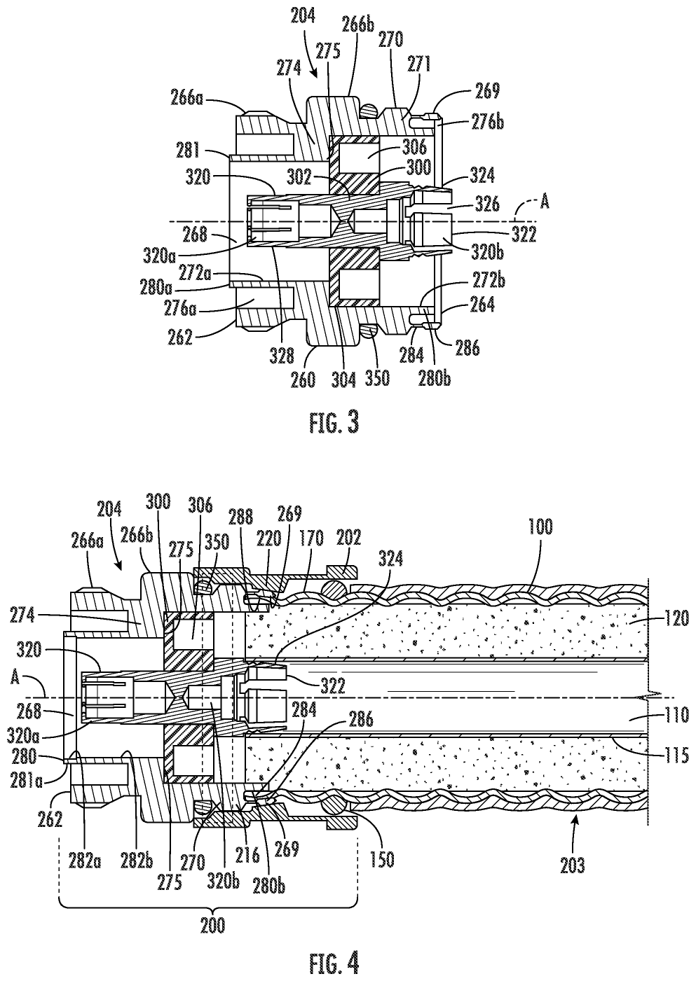

The rear outer body 202 additionally includes an engagement element 220 configured for positioning adjacent to the seal 150 and engaging the corrugated outer conductor 125 upon coupling of the rear outer body 202 with a portion of the corrugated coaxial cable 100 in the prepared state. Specifically, the engagement element 220 inwardly extends toward the prepared end 170 of the corrugated coaxial cable 100 for direct engagement with the corrugated outer conductor 125. The engagement element 220 includes a seal engagement face 230 configured for positioning adjacent the seal 150, an internal surface 232 configured for engagement with the corrugated outer conductor 125, and an angled face 234 positioned angularly at a face angle α, with respect to the seal engagement face 230. The face angle α can range from about 5 degrees to about 30 degrees. In some embodiments, the angled face 234 is also configured for engagement with the corrugated outer conductor 125. The angled face 234 also facilitates entry the prepared end 170 of the corrugated coaxial cable 100 into the rear outer body 202 and acts as a stop for the seal 150. The rear outer body 202 additionally includes include forward inner diameters 222, 224 adjacent the front end 208 and an rearward diameter 225 adjacent the back end 210. The rearward diameter 225 of the rear outer body 202 is of sufficient size to slide over the seal 150. The forward inner diameters 222, 224 are configured for engagement with the seal 150, the corrugated coaxial cable 100, and the front subassembly 204, as will be described with respect to FIG. 4.

Referring to FIGS. 3 and 4, the front subassembly 204 includes a front body shell 260, an insulator 300, and a contact element 320. The front body shell 260 has a first shell end 262, a second shell end 264, external gripping portions 266a, 266b, and a body shell opening 268 extending between the first shell end 262 and the second shell end 264 with respect to longitudinal axis A. The front body shell 260 also has a deformable end portion 269, an annular shoulder 270, and internal diameters 272a, 272b. The deformable end portion 269 includes a neck portion 284 connected to the annular shoulder 270 and a nub portion 286 connected to the neck portion 284. The neck portion 284 has a cross-section that is sufficiently thin and configured to flex, thus allowing the nub portion 286 to move when a force is applied to the front body shell 260. The annular shoulder 270 cooperates with the threaded portion 216 of rear outer body 202 to secure the rear outer body 202 to the front subassembly 204.

In addition to the aforementioned elements, the front body shell 260 includes an intermediary shell portion 274, a forward annular extension 280a, and a rearward annular extension. The intermediary shell portion 274 is configured within the front body shell 260 to form a shoulder 275 upon which the insulator 300 is positioned against. The forward annular extension 280a has an extension end 281a that extends slightly past the first shell end 262 and a first annular channel 276a positioned between the external gripping portion 266a and the forward annular extension 280a. The forward annular extension 280a preferably includes first and second extension diameters 282a, 282b with the first extension diameter 282a being slightly larger than the second extension diameter 282b. Extending from a bottom portion 271 of the annular shoulder 270 is the rearward annular extension 280b. The rearward annular extension 280b extends within the front body shell 260 such that the second shell end 264 is spaced apart from the extension end 281b of the rearward annular extension 280b. And disposed between the rearward annular extension 280b and the deformable end portion 269 is a second annular channel 276b. The front body shell 260 is preferably made from one or more metallic materials, e.g. brass and brass composite materials, and plated with a conductive, corrosion resistant material such as a nickel-tin alloy.

Also included within the front subassembly is the insulator 300. The insulator includes a bore 302 aligned with respect to longitudinal axis A and an outer surface 304. In preferred configurations, the insulator 300 further includes an insulator channel 306. The insulator 300 is manufactured from an electrically insulative material Examples of such materials include, but are not limited to, foam-based materials and acetal.

As shown particularly in FIGS. 3 and 4, the contact element 320 includes a contact back end 322, having a tapered portion 324 that engages with the center conductor 105. The contact element 320 also preferably has a plurality of slots 326 at the contact back end 322 which allow the contact element 320 to flex as necessary and make physical and electrical contact with the center conductor 105. The contact element 320 additionally includes a contact front end 328 that has a female configuration to receive a male configured mating component (not shown). But alternatively, the contact front end 328 of contact element 320 may have a male configuration. The contact element 320 is made from a metallic material such as beryllium copper, is preferably heat treated and is preferably plated with a conductive, corrosion resistant material such as a nickel-tin alloy.

The installation of the connector assembly 200 will now be described with respect to FIG. 4. If not already separated from one another, the rear outer body 202 and front subassembly 204 should be separated from one another, i.e., unscrewed from one another in preferred embodiments, before assembly. The rear outer body 202 is then placed over the prepared corrugated coaxial cable 100, i.e. after the jacket 130 of the corrugated coaxial cable 100 has been stripped back to expose a portion of the corrugated outer conductor 125. During installation, the contact element 320 aligns and engages with the inside diameter 110 of the center conductor 105. To the extent that the contact element 320 is larger than the inside diameter 110 of the center conductor 105, slots 326 allow the contact element 320 to radially compress to fit within the center conductor 105. Simultaneously, the deformable end portion 269 is inwardly urged when pushed against the engagement element 220 such that the corrugated outer conductor 125 is pinched between the deformable end portion 269 and the rearward annular extension 280b. The pinching of the corrugated outer conductor 125 occurs within a pinching space 288 formed between the deformable end portion 269 and the rearward annular extension 280b. The front subassembly 204 also preferably includes a seal 350 configured to prevent exposure to water and other elements.

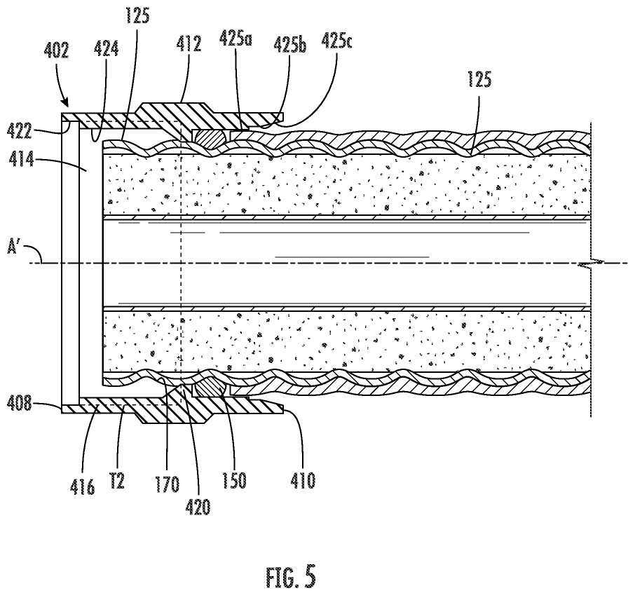

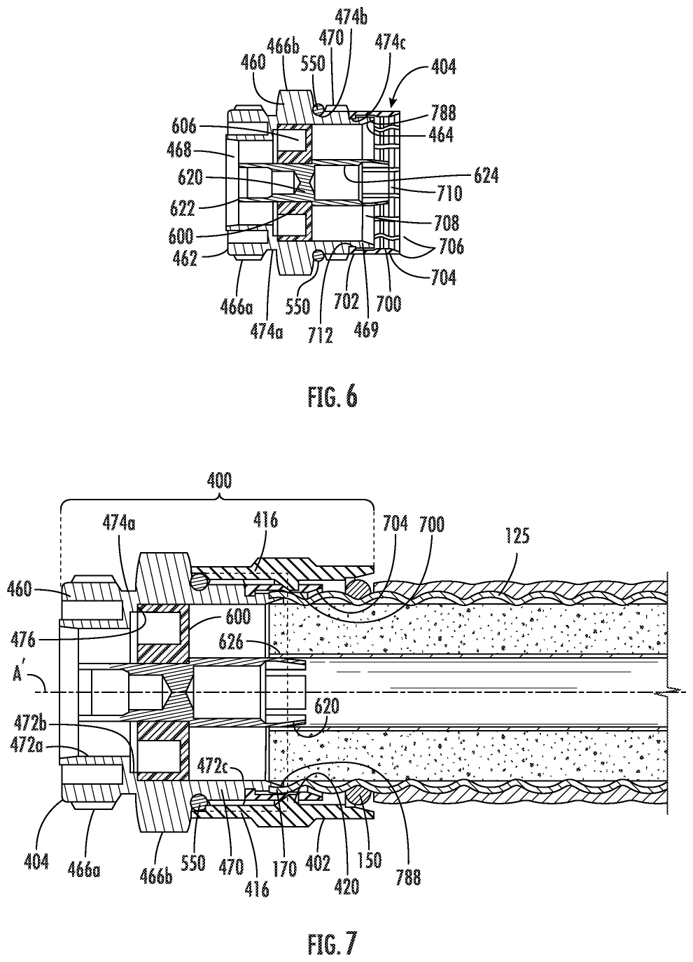

Referring to FIGS. 5-7, a second embodiment of a connector assembly 400 (FIG. 7) similarly includes a rear outer body 402 and a front subassembly 404. The rear outer body 402 has a front body end 408, a back body end 410, an external gripping portion 412, and an outer body opening 414, extending between the front body end 408 and the back body end 410 with respect to a longitudinal axis A′. The rear outer body 402 preferably includes a threaded portion adjacent the front body end 408, represented schematically by dashed line T2, for threadingly engaging the front subassembly 404 with the rear outer body 402. The rear outer body is preferably made from at least one metallic material such as brass and plated with a conductive, corrosion resistant material such as a nickel-tin alloy.

The rear outer body 402 additionally includes an inwardly extending engagement element 420 configured for positioning adjacent to the seal 150 and sliding engagement with the corrugated outer conductor 125 upon coupling with the corrugated outer conductor 125. Preferably, the seal 150 is configured for positioning adjacent to or within an outermost valley 126 of the corrugated outer conductor 125 such that the engagement element 420 abuts against the seal, as particularly shown in FIG. 5. The rear outer body 402 additionally includes forward inner diameters 422, 424 on the front end 208 and rearward diameters 425a, 425b, 425c. The forward inner diameters 422, 424 are configured for engagement with the front subassembly 404. And the rearward diameters 425a, 425b, 425c are of sufficient size to slide over the seal 150.

Referring to FIGS. 6 and 7, the front subassembly 404 includes a front body shell 460, a seal 550, an insulator 600, a contact element 620, and a ferrule 700. The front body shell 460 has a front shell end 462, a back shell end 464, external gripping portions 466a, 466b, and a body shell opening 468 extending between the front shell end 462 and the back shell end 464 with respect to a longitudinal axis A′. The front body shell 460 also has an end portion 469, which may or may not be deformable, an annular shoulder 470, internal diameters 472a, 472b, 472c, external recesses 474a, 474b, 474c, and an interior stop 476. The external recess 474b is configured such that the seal 550 can be seated therein and the external recess 474c is configured to seat a portion of the ferrule 700. The annular shoulder 470 cooperates with the threaded portion 416 of the rear outer body 402 to secure the rear outer body 402 with the front subassembly 404. The front body shell 460 is preferably made from at least one metallic material, such as brass, and plated with at least one conductive, corrosion resistant material, such as a nickel-tin alloy.

The seal 550 is configured to prevent exposure to water and other elements, particularly upon assembly with the rear outer body 402, as shown in FIG. 7. The seal 550 is shown having a substantially circular cross-section, however, the cross-sectional shape is exemplary. The seal may have any cross-sectional shape. The seal material is elastomeric and thus conformable to the seal both the recess and the space between the rear outer body and the front body shell upon assembly.

The insulator 600 preferably has the same configuration as the insulator 300 of the first connector assembly embodiment. Accordingly, the insulator includes a bore 602 aligned with respect to longitudinal axis A′ and an outer surface 484. In preferred configurations, the insulator further includes an insulator channel 606. In the connector assembly 400, the insulator 600 is positioned to abut against the interior stop 476 of the front body shell 460. The insulator 600 is also preferably made from an electrically insulative material such as a foam-based material or acetal.

As shown particularly in FIG. 7, the contact element 620 includes a contact front end 622 and a contact back end 624. The contact front end 622 has a female configuration to receive a male configured mating component (now shown). The back end 624 includes a tapered portion 626 that engages with the center conductor 105. The contact element 620 is also configured to flex as necessary and make physical and electrical contact with the center conductor 105. The contact element is also preferably made from at least one metallic material, such as beryllium copper. In preferred embodiments, the contact element is also heat treated and plated with at least one conductive, corrosion resistant material, e.g. a nickel-tin alloy.

The ferrule 700 is configured to engage with the corrugated outer conductor 125 of the corrugated coaxial cable 100 after the jacket 130 has been stripped back to expose a portion of the corrugated outer conductor 125. The ferrule is preferably made of at least one metallic material, such as brass, and plated with at least one conductive material, such as nickel-tin.

Referring back to FIG. 6, the ferrule 700 includes a front ferrule end 702, a back ferrule end 704, a plurality of slots 706, a tapered surface 708, and a plurality of annular ridges 710. The front ferrule end 702 has an inwardly extending projection 712 that fits within the external recess 474c. At the opposite end, the back ferrule end 704 is configured for engagement with the corrugated outer conductor 125. The plurality of slots 706 in the ferrule 700 provide the ferrule 700 with spring-like characteristics. Accordingly, the plurality of slots 706 facilitate spring-like engagement of the ferrule 700 upon coupling with the corrugated outer conductor 125, the rear outer body 402 and the engagement element 420. The plurality of annular ridges 710 also facilitate engagement with the corrugated outer conductor 125 by nature of the ridges themselves.

Upon coupling of the rear outer body 402 with the ferrule 700, as shown in FIG. 7, the corrugated outer conductor is positioned within a gripping space 788 formed between the end portion 469 of the front body shell 404 and the ferrule 700. Also upon coupling of the front body shell 404 with the ferrule 700 and the rear outer body 402, at least one of the annular ridges 710 (FIG. 6) engages with the outermost valley 126 of the corrugated outer conductor 125 such that a portion of the ferrule 700 is sandwiched between the engagement element 420 and the corrugated outer conductor 125.

For the purposes of describing and defining the subject matter of the disclosure it is noted that the terms “substantially” and “generally” may be utilized herein to represent the inherent degree of uncertainty that may be attributed to any quantitative comparison, value, measurement, or other representation

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the embodiments disclosed herein should be construed to include everything within the scope of the appended claims and their equivalents.

What is claimed is:

1. A connector assembly (200) for attachment to a corrugated coaxial cable (100), the corrugated coaxial cable (100) comprising a center conductor (105), a dielectric (120) surrounding the center conductor (105), and a corrugated outer conductor (125) surrounding the dielectric (120), the connector assembly (200) comprising:
a rear outer body (202) to be received over a portion of the corrugated coaxial cable (100), the rear outer body (202) comprising an engagement element (220); and
a front subassembly (204) to be partially inserted into the rear outer body (202), the front subassembly (404) comprising:
a front body shell (260) comprising a deformable end portion (269) and a rearward annular extension (280b) spaced apart from the deformable end portion (269) such that a pinching space (288) is formed between the deformable end portion (269) and the rearward annular extension (280b),
wherein upon coupling of the rear outer body (202) with the front body shell (260), a portion of the corrugated outer conductor (125) is positioned within the pinching space (288) and the deformable end portion (269) is inwardly urged toward the rearward annular extension (280b) by the engagement element (220) such that the portion of the corrugated outer conductor (125) is pinched while positioned within the pinching space (288).

2. The connector assembly of claim 1, wherein the deformable end portion extends beyond an annular extension.

3. The connector assembly of claim 1, wherein the front body shell further comprises an annular shoulder coupled to the deformable end portion and wherein the annular shoulder cooperates with the rear outer body to secure the rear outer body to the front subassembly.

4. The connector assembly of claim 1, wherein the deformable end portion comprises a neck portion and a nub portion, and wherein the neck portion is configured to flex when a force is applied to the nub portion.

5. The connector assembly of claim 3, wherein a neck portion is attached to the annular shoulder.

6. The connector assembly of claim 1, wherein a nub portion is attached to a neck portion and wherein the nub portion is inwardly urged upon coupling of the rear outer body with the front subassembly.

7. A connector assembly (400) for attachment to a corrugated coaxial cable (100), the corrugated coaxial cable (100) comprising a center conductor (105), a dielectric (120) surrounding the center conductor (105), and a corrugated outer conductor (125) surrounding the dielectric (120), the connector assembly (400) comprising:
a rear outer body (402) to be received over a portion of the corrugated coaxial cable (100), the rear outer body comprising an engagement element (420) that slidingly engages with the corrugated outer conductor (125) upon coupling, and
a front subassembly (404) to be partially inserted into the rear outer body (402), the front subassembly (404) comprising:
a front body shell (460) comprising an end portion (469) and a ferrule (700) spaced apart from the end portion (469) such that a gripping space (488) is formed between the end portion (469) and the ferrule (700)
wherein upon coupling of the rear outer body (402) with the front body shell (460), a portion of the corrugated outer conductor (125) is positioned within the gripping space (488) and the ferrule is inwardly urged toward the end portion (469) by the engagement element (420) such that the portion of the corrugated outer conductor (125) is gripped while positioned within the gripping space (788).

8. The connector assembly of claim 7, wherein the ferrule is configured to extend beyond the end portion.

9. The connector assembly of claim 7, wherein the front body shell further comprises an annular shoulder coupled to the end portion, and wherein the annular shoulder cooperates with the rear outer body to secure the rear outer body to the front subassembly.

10. The connector assembly of claim 7, wherein the ferrule comprises a plurality of annular ridges and wherein at least one of the plurality of annular ridges engages an outermost valley of the corrugated outer conductor upon engagement of the corrugated outer conductor with the front subassembly.

11. The connector assembly of claim 7, wherein the front body shell comprises an external recess configured to seat a ferrule portion of the ferrule.

12. The connector assembly of claim 7, wherein the ferrule comprises a front ferrule end having an inwardly extending projection configured to fit within an external recess of the front body shell.

13. The connector assembly of claim 7, wherein the ferrule comprises a plurality of slots that facilitate spring-like engagement of the ferrule with the corrugated outer conductor upon assembly with the rear outer body.

14. A method of making a connector assembly to be attached to a corrugated coaxial cable (100), the corrugated coaxial cable (100) comprising a center conductor (105), a dielectric (120) surrounding the center conductor (105), and a corrugated outer conductor (125) surrounding the dielectric (120), the method comprising:
forming a rear outer body (202) to be received over a prepared end of the corrugated coaxial cable, wherein the rear outer body comprises an engagement element defined therein;
forming a front subassembly to engage the rear outer body, the front subassembly comprising a front body shell (260) having a deformable end portion (269) and a rearward annular extension (280b) spaced apart from the deformable end portion (269) such that a pinching space (288) is formed between the deformable end portion (269) and the rearward annular extension (280b),
coupling the rear outer body (202) with the front body shell (260),
positioning a portion of the corrugated outer conductor (125) within the pinching space (288);
inwardly urging the deformable end portion (269) toward the rearward annular extension (280b) via the engagement element (220); and
pinching the portion of the corrugated outer conductor (125) positioned within the pinching space (288).
